(19) United States
(12) Patent Application Publication
(10) Pub. No.: US 2002/0021008 A1
(43) Pub. Date: Feb. 21, 2002

(54) Method for generating electricity from pressurized irrigation systems

(76) Inventor: Dennis J. Hurley, Marrero, LA (US)

Correspondence Address: DENNIS J. HURLEY, P. O. BOX 702, 34 MADEWOOD DR, MARRERO, LA, 70073, US

(21) Appl. No.: 09/811,890

(22) Filed: Mar. 19, 2001

Related U.S. Application Data
(60) Provisional application No. 60/190,487, filed on Mar. 20, 2000.

(51) Int. Cl. H02P 9/04; F03B 13/00

(52) U.S. Cl. 290/54

(57) ABSTRACT

The system would enable properties, such as golf courses that have constantly pressurized irrigation systems, to generate electricity in remote areas of the golf course. This system would consist of an impulse turbine, such as a Pelton wheel, in combination with an electric valve operated by a remote signaling, and signaled on and off through the use of a circuit board to run the turbine on demand.

I claim Benefit of Provisional Patent No. 60/190487 Filed on Mar. 20, 2000.

### BACKGROUND OF THE INVENTION

1. Field of the Invention

The present invention relates to the need for places such as golf courses to run electrical apparatuses, such as pumps, fans, lights, hand tools, etc., on remote areas of the golf course.

2. General Background

In the present state of the art, if a golf course wants to run an electrical apparatus, it must either run an electrical line from the nearest point, or build a solar or wind powered system to charge a battery bank. Typically, golf courses do not have access to electricity on all areas of the golf course, and the cost to run electrical line to power an apparatus is many times prohibitively expensive. Systems such as solar panels and wind power are made very expensive by the fact that they have to charge a battery bank during the time the apparatus is not running. These battery banks are expensive, heavy, require maintenance, and interfere with the scenery of the golf course. In addition, solar and wind power systems can be unpredictable because of weather conditions that reduce the amount of energy that they can collect. No other system presently available, such as solar or wind, has enough power to operate the apparatus without first storing power in an expensive battery bank. Therefore, if an apparatus needs to be run constantly, these systems won't work, and the golf course is forced to spend the money to run an electrical line if they want to operate the apparatus.

### SUMMARY OF THE PRESENT INVENTION

Although golf courses typically don't have access to electricity, they are normally constructed with very powerful and sophisticated irrigation systems. This invention would utilize the transmission system of these irrigation systems to transmit the power from the pump station to the area of the golf course where electricity is needed. With this system, the golf course owner would tap into the irrigation system at a point close to where the electrical apparatus was needed, and attach the current invention. Since pumps and fans are needed on demand, this invention would combine a turbine with a signaling device from the apparatus, such as a float switch for a pump, a thermostat for a fan, a light meter for remote lighting, or a simple on-off switch for hand tools. The signal would then be sent by way of a circuit board, to an electric valve to open and start the flow of water from the constantly pressurized irrigation system to turn the turbine and power the device. A golf course irrigation system would normally operate with 100 lbs. of pressure in the lines, and have the capability of pumping up to 1500 gallons of water. Because of the tremendous power within these systems, this invention will, in most cases, eliminate the need to charge a battery bank, as the electrical output created through the turbine can be engineered to be more than the power requirement of the apparatus. No other system presently available, such as solar or wind, has enough power to operate the apparatus without first storing power in an expensive battery bank. Although there may be a small battery included in the design, it would be for the purpose of controlling the flow of electricity, and be minimal in comparison to the battery capacity needed for storage in a wind or solar powered system. Should conditions require the use of storage batteries, this system could easily do this, and the controls and automatic valve would shut off the flow of water to the turbine when the battery bank was fully charged; thus saving power at the main pump station. Since the set up will be relatively light in the absence of a battery bank, the system could be made portable going from site to site on the course. The golf course would only need to make permanent taps into the irrigation system to quickly be able to roll a unit to a prepared area. Thus, one apparatus could be used in more than one location on the golf course.

Therefore, it is the principal object of the present invention to provide an inexpensive means to supply power to remote electrical appliances, in areas such as golf courses that have constantly pressurized irrigation systems.

It is a further object of the invention that this system will have enough power to run electrical apparatuses continually.

It is a further object of the invention that this system will practically eliminate the need for storage batteries in these applications.

It is a further object of the invention that this turbine, in combination with a device that sends a signal when power is needed, plus a circuit board that opens a valve to start the flow of water, will supply electricity on demand, and will shut off when the device no longer needs power, thus saving power at the pumping station.

It is a further object of the present invention to have the system be able to be portable, so that one unit could be used in many areas of the course with little extra expense.

### BRIEF DESCRIPTION OF THE DRAWINGS

### DETAILED DESCRIPTION OF THE PREFERRED EMBODIMENT

The present invention provides a system for generating electricity in remote locations, on such properties as golf courses, when there is a constantly pressurized irrigation system. The system is designed to solve the problem of running electricity long distances to remote locations, or having to build a solar or wind powered system that must have an expensive battery bank that requires charging.

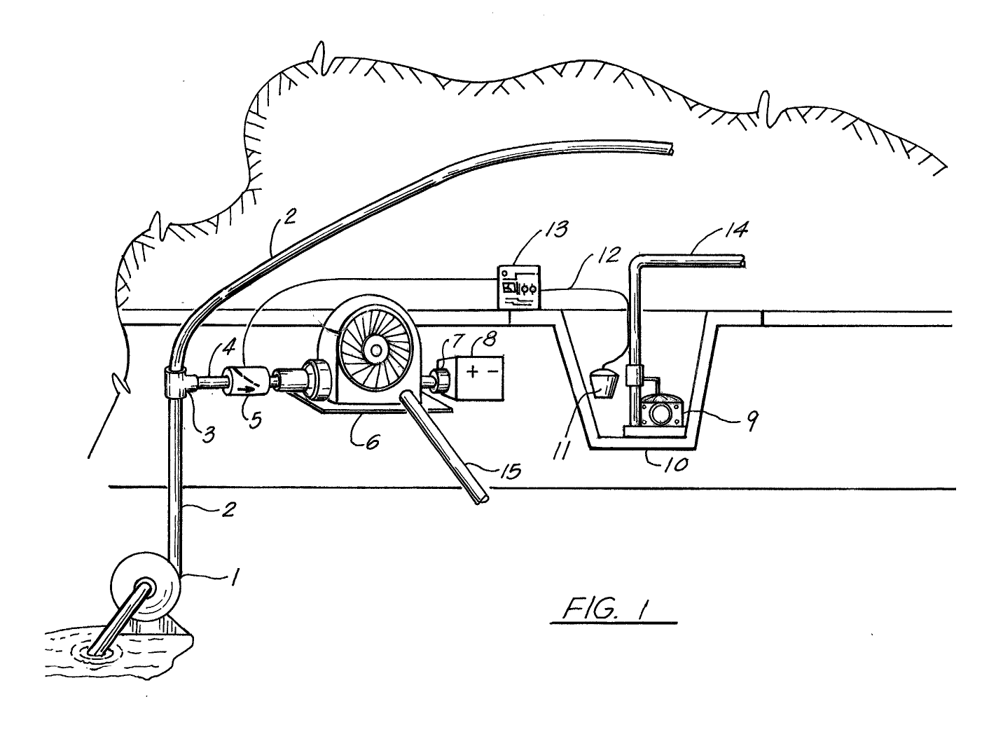

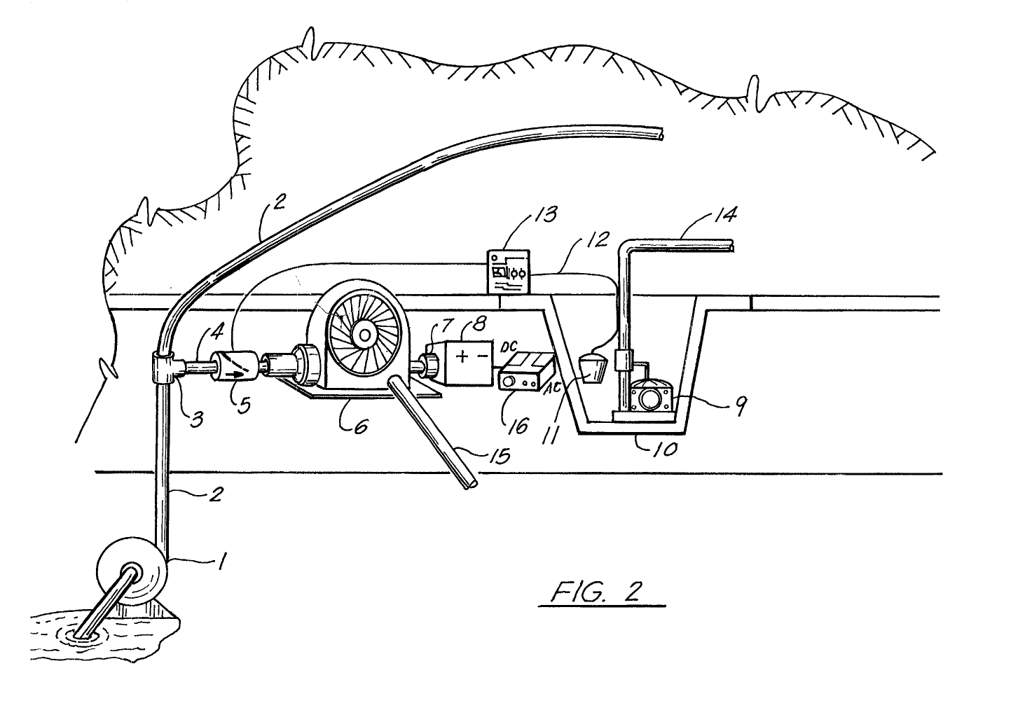

Therefore, to solve this problem, FIG. 1 and FIG. 2 illustrate how this system would work. In FIG. 1, item 1 represents the main pumping station located on the golf course that keeps the irrigation lines constantly charged. Item 2 represents the main irrigation line by which water is transmitted to remote, areas of the golf course to supply water to irrigation heads on the course. Item 3 is the area where a line would be tapped into the main irrigation water to bring water to the turbine where needed. Item 4 is the piping that transmits the water to the turbine. Item 5 is the automatic valve that will open when water is needed to run the turbine. Item 6 is the turbine at the end of this line. Item 7 is the alternator that regulates the flow of electricity to the apparatus as needed. Item 8 is an optional battery, but will normally utilize a small battery to buffer the flow through the line and excite the fields. Item 9 is the apparatus that will be running, this could be a pump, fan, light set hand tolls, or other device, such as a concession stand or shelter requiring electricity on the course. This device would be a dc powered unit, so as to use the power as it comes through the system. Item 10 is the sump that collects water where the pump sits. Item 11 is a signaling device that is activated when the device is needed. In the case of a pump, this would be a float. With a fan, it would be a thermostat or wind meter. With a light kit, it would be a light meter, or in the event of a hand tool or the like, it could be simply an on-off switch. Item 12 is the wiring that connects the signaling device to a printed circuit board. Item 13 is the circuit board that receives the signal and sends it to the automatic valve to start the flow of water to the turbine. Item 14 is the discharge line that in the case of a pump carries the water out of the sump. Item 15 is the flow line from the turbine that takes the water that runs the turbine and discharges it into an existing drainage system or lake.

FIG. 2 shows this same scenario, except it utilizes a DC to AC inverter to change the electricity to AC so that the unit can power AC appliances.

Therefore, in this configuration, as the water falls into the sump 10, and raises the water level in the sump, the float 11 rises and sends a signal through wire 12 to the printed circuit board 13. The circuit board 13 sends a signal through the wire 12 to the automatic valve 5, and starts the flow of water to the turbine 6. The turbine turns, thus generating electricity, and sends the power through the alternator 7 and an optional battery 8 through an inverter 16 that converts DC to AC and runs the apparatus 9. In this case, this is an AC pump that then pumps water into the discharge pipe 14, and the water is removed. When the water level goes down, the float 10 will send a signal to the valve 5 to close; thus saving electricity at the pump station.

Because many varying and different embodiments may be made within the scope of the inventive concept herein taught, and because many modifications may be made in the embodiments herein detailed, in accordance with the descriptive requirement of the law, it is to be understood that the details herein are to be interpreted as illustrative, and not in a limiting sense.

What is claimed as an invention is:

1. A system that generates electricity on properties, such as golf courses, in remote locations by utilizing the power of a pressurized irrigation system in conjunction with a turbine and a signaling device that sends a signal by way of a circuit board to generate electricity on demand by opening a valve that starts the flow of water to the turbine.

2. The system in claim 1 that generates enough power to run apparatuses used on properties such as golf courses without the need to power a large battery bank.

3. The system in claim 1 system that can be used to run DC apparatuses directly, or convert the electricity to AC, for AC apparatuses.

4. The system in claim 1 that can be made portable, so that one set-up can be used in many different locations for little additional expense.

5. A system in claim 1 that can be used to power many different types of devices in conjunction with varying types of signaling devices, or an on-off switch.

6. The system in claim 1 that generates enough power that it can be used to power sites, such as concession stand shelters, etc., when needed.

7. A system that generates electricity on properties, such as golf courses, in remote locations by utilizing the power of a pressurized irrigation system in conjunction with a turbine and a signaling device that sends a signal by way of a circuit board to generate electricity on demand by opening a valve that starts the flow of water to the turbine.

8. The system in claim 1 that generates enough power to run apparatuses used on properties such as golf courses without the need to power a large battery bank.

9. The system in claim 1 system that can be used to run DC apparatuses directly, or convert the electricity to AC, for AC apparatuses.

10. The system in claim 1 that can be made portable, so that one set-up can be used in many different locations for little additional expense.

11. A system in claim 1 that can be used to power many different types of devices in conjunction with varying types of signaling devices, or an on-off switch.

12. The system in claim 1 that generates enough power that it can be used to power sites, such as concession stand shelters, etc., when needed.
